(19) United States
(12) Patent Application Publication
(10) Pub. No.: US 2025/0337275 A1
(43) Pub. Date: Oct. 30, 2025

(54) AUGMENTED REALITY-BASED SMART SOCKET VISUALIZATION

(71) Applicant: Honeywell International Inc., Charlotte, NC (US)

(72) Inventors: Kanhayia Kumar, Bangalore (IN); Nilesh Chaudhari, Bangalore (IN); Rajiv R. Singh, Bangalore (IN); Siddhartha Chatterjee, Cumming, GA (US); Venugopal Kilingar Nadumane, Bangalore (IN)

(21) Appl. No.: 19/190,051

(22) Filed: Apr. 25, 2025

(30) Foreign Application Priority Data
Apr. 26, 2024 (IN) 202411033305

(51) Int. Cl. H02J 13/00; G06K 19/06; G06T 11/60

(52) U.S. Cl. CPC H02J 13/0005; G06T 11/60; H02J 13/00024; G06K 19/06037; G06T 2200/24

(57) ABSTRACT

Methods and systems for visualizing and controlling smart electrical sockets are disclosed. A mobile device with a camera captures an image of a smart electrical socket and displays the image on its screen. The mobile device determines a socket's unique identifier and receives electrical parameters associated with power delivered through the socket's plug receptacle. These parameters are displayed concurrently with the socket image, visually associated such as through superimposition or connecting lines. The smart socket includes sensors for monitoring electrical parameters, a controller for power switching, and a wireless interface. The mobile device can receive parameters directly from the socket, via a gateway device or from a server connected to the gateway device. The system enables pairing between smart sockets and gateway devices using visual codes. Control of the smart socket is achieved through user gestures on the mobile device interface, allowing power switching and adjustment of power levels.

### RELATED APPLICATIONS

This application claims the benefit of Indian Provisional Application No. 202411033305 filed Apr. 26, 2024, which application is incorporated by reference herein.

### TECHNICAL FIELD

The present disclosure relates generally to connected power systems that employ smart electrical sockets, and more particularly to connected power systems that utilize augmented reality in operation.

### BACKGROUND

Connected power systems can include a large number of individual smart electrical sockets. Each of the smart electrical sockets is able to monitor performance of the smart electrical socket, including power consumption and temperature. Each of the smart electrical sockets may be considered as generating a large amount of data, that can be useful if appropriately displayed. Each of these smart electrical sockets need to be commissioned, which can be time consuming. What would be desirable are methods of visualizing relevant parameters such as power, energy, temperature, current, voltage, and others in a connected power system. What would be desirable are methods of pairing a smart electrical socket with a gateway device in a connected power system. What would be desirable are methods of controlling a smart electrical socket in a connected power system.

### SUMMARY

The present disclosure relates generally to connected power systems that employ smart electrical sockets, and more particularly to connected power systems that utilize augmented reality in operation. An example may be found in a method for visualizing one or more parameters associated with a smart electrical socket. The smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance, if any, through the plug receptacle. The smart electrical socket further including a wireless interface. The illustrative method includes a mobile device determining an identifier of the smart electrical socket. The mobile device has a camera and a display and the camera captures an image of the smart electrical socket. The mobile device displays the image of the smart electrical socket on the display of the mobile device. The mobile device uses the identifier of the smart electrical socket to request and receive one or more of the sensed electrical parameters associated with the power delivered by the smart electrical socket to the connected electrical appliance, if any, through the plug receptacle, and concurrently displays the one or more electrical parameters and the image of the smart electrical socket on the display with the one or more electrical parameters visually associated with the smart electrical socket on the display.

Another example may be found in a method of pairing a smart electrical socket with a particular gateway device. The smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance if any through the plug receptacle. The smart electrical socket further includes a wireless interface. The illustrative method includes selecting a gateway device. An image of a visual code on the smart electrical socket is captured using a camera of a mobile device. A smart electrical socket identifier is extracted from the image of the visual code for the smart electrical socket. The smart electrical socket identifier is provided to the selected gateway device. The selected gateway device is instructed to establish a pairing with the smart electrical socket that is associated with the smart electrical socket identifier. This may be repeated for other smart electrical sockets in a facility.

Another example may be found in a method of controlling a smart electrical socket from a mobile device. The smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance if any through the plug receptacle, and a wireless interface. The illustrative method includes capturing an image of the smart electrical socket using a camera of a mobile device and displaying at least part of the image on a display of the mobile device. A gesture is received from a user via a user interface of the mobile device to control one or more actions of the smart electrical socket. The mobile device sends one or more control commands that are based at least in part on the received gesture. One or more actions of the smart electrical socket are controlled based on the one or more control commands sent by the mobile device.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative connected power system;

FIG. 2 is a schematic block diagram showing an illustrative architecture;

FIGS. 3A and 3B are flow diagrams that together show an illustrative method for visualizing one or more parameters associated with a smart electrical socket;

FIG. 4 is a flow diagram that shows an illustrative method for pairing a smart electrical socket with a gateway device;

FIGS. 5A and 5B are flow diagrams that together show an illustrative method for controlling a smart electrical socket from a mobile device; and

FIG. 6 is a schematic block diagram showing parameters associated with a smart electrical socket overlaid on an image of the smart electrical socket on a display of a mobile device.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

Every building or building site has many assets such as equipment and appliances that are connected to electrical sockets of the building. Sometimes, some of the electrical sockets are smart electrical sockets that allow a user to remotely turn on and turn off power provided by the smart electrical socket to a piece of equipment or appliance that is plugged into the smart electrical socket.

This disclosure relates generally to methods and system for providing augmented reality based smart socket visualization. The augmented reality based smart socket visualization may be useful in a number of use cases including, for example, visualization of real time smart socket parameters overlaid on an image of the smart socket, visualization of smart socket and/or gateway/hub commissioning parameters useful in commissioning the smart sockets and/or gateway/hubs, and visualization of smart socket and/or gateway/hub maintenance parameters useful in maintaining the smart sockets and/or gateway hubs. These are just examples.

In one particular example, real-time socket consumption data for a particular smart electrical socket is obtained and overlaid on an image of the particular smart electrical socket. This may help in visualizing the operation of the particular smart electrical socket and/or the appliance connected to the smart electrical socket. This may also help in correctly identifying the particular smart electrical socket and provide an intuitive way of managing such assets. Smart electrical socket parameters that may be overlaid on an image of the smart electrical socket may include, for example, socket status (e.g. ON, OFF, DIM, LOCK ON, LOCK OFF), plug load (load on the socket from a connected appliance), energy consumption (energy consumed by the connected appliance), cost savings, current operation schedule period, temperature inside of the smart electrical socket, electrical trends, voltage, current and/or other socket parameters. In some cases, the smart electrical socket may be turned on or off via the augmented reality user interface to aid in diagnosing electrical connections and/or installation issues. Commissioning is made easier by visually viewing the sockets and hubs in a room and pairing the same using the augmented reality user interface. Recommendations to save energy may be visually overlaid on an image of the smart electrical sockets and/or hubs via the augmented reality user interface. These are just examples.

In some cases, the smart electrical sockets may be scanned using a connected power augmented reality (CP AR) application program running on a mobile device. The mobile device may be, for example, a smart phone, tablet, laptop and/or any other suitable mobile device. The smart electrical sockets may include a code that encodes a unique identifier of the smart electrical socket. The code may be, for example, a QR code, a bar code, an RFID code and/or any other suitable code. In some cases, the code is captured in an image taken by a camera of the mobile device, and the identifier may be determined by decoding the code. In some cases, the code with the identifier may be received wirelessly from the smart electrical socket (e.g. via RFID, NFC, Bluetooth). With the identifier of the smart electrical socket known, the CP AR APP may connect to a server and/or gateway/hub that is in communication with the smart electrical socket and retrieve the live and/or historical details (e.g. parameters) for the smart electrical socket for use by the CP AR APP to overlay the live and/or historical details on or adjacent to an image of the smart electrical socket captured by the mobile device.

An illustrative method may facilitate visualizing one or more parameters associated with a smart electrical socket, wherein the smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance, if any, through the plug receptacle, the smart electrical socket further including a wireless interface. The one or more of the sensed electrical parameters associated with the power delivered by the smart electrical socket to the connected electrical appliance through the plug receptacle may include, for example, one or more of a voltage value, a current value, a power value and an energy value. These are just examples.

The illustrative method may include a mobile device determining an identifier of the smart electrical socket. In some cases, the mobile device has a camera and a display. The camera may capture an image of the smart electrical socket and the mobile device may display the image of the smart electrical socket on the display of the mobile device. The mobile device may use the identifier of the smart electrical socket to request and receive one or more of the sensed electrical parameters associated with the power delivered by the smart electrical socket to the connected electrical appliance, if any, through the plug receptacle, and concurrently display the one or more electrical parameters and the image of the smart electrical socket on the display of the mobile device with the one or more electrical parameters visually associated with the smart electrical socket on the display. In some cases, visually associating the one or more electrical parameters with the smart electrical socket on the display may include superimposing the one or more electrical parameters on the image of the smart electrical socket. In some cases, visually associating the one or more electrical parameters with the smart electrical socket on the display may include providing an association line or other indicator between the one or more electrical parameters that are displayed on the display and the smart electrical socket shown in the image of the smart electrical socket. In some cases, the image may be a static image captured by the camera of the mobile device or a real-time video stream of the smart electrical socket as captured in real-time by the camera of the mobile device. When the image is a real-time video stream captured by the camera of the mobile device, the position of the smart electrical socket in the Field-Of-View (FOV) of the real-time video stream may change over time as the mobile device is moved around by a user of the mobile device. The indication between the one or more electrical parameters that are displayed on the display and the smart electrical socket may be updated in real-time as the position of the smart electrical socket moves in the FOV of the real-time video stream.

In some cases, the method may include the mobile device determining the identifier of the smart electrical socket by extracting the identifier from the image of the smart electrical socket, wherein the identifier is encoded in a visual code on the smart electrical socket. In some cases, the method may include the mobile device wirelessly receiving a message from the wireless interface of the smart electrical socket, wherein the mobile device determines the identifier by extracting the identifier from the received message. In some cases, the method may include the smart electrical socket sending one or more messages including an identifier of the smart electrical socket to a gateway device via the wireless interface of the smart electrical socket, and the mobile device wirelessly receiving a gateway message from the gateway device and determining the identifier of the smart electrical socket by extracting the identifier from the received gateway message.

In some cases, the method may include the mobile device requesting and receiving from the smart electrical socket one or more of the sensed electrical parameters associated with the power delivered by the smart electrical socket to the connected electrical appliance, if any, through the plug receptacle. The method may include the smart electrical socket sending one or more messages including one or more of the sensed electrical parameters associated with the power delivered by the smart electrical socket to the connected electrical appliance to a gateway device via the wireless interface of the smart electrical socket, and the mobile device may request and receive from the gateway device one or more of the sensed electrical parameters associated with the power delivered by the smart electrical socket to the connected electrical appliance. In some cases, the method may include the mobile device requesting and receiving from a remote server one or more of the sensed electrical parameters associated with the power delivered by the smart electrical socket to the connected electrical appliance, if any, through the plug receptacle.

In some cases, the one or more parameters associated with the smart electrical socket include one or more status parameters that indicate whether the smart electrical socket is providing power to the plug receptacle or not providing power to the plug receptacle, and the method includes concurrently displaying one or more of the status parameters on the display of the mobile device with the one or more status parameters visually associated with the smart electrical socket on the display. In some cases, the one or more parameters associated with the smart electrical socket may include a temperature parameter that indicates a current temperature inside of the smart electrical socket, and the method may include concurrently displaying the temperature parameter on the display of the mobile device with the temperature parameter visually associated with the smart electrical socket on the display. In some cases, visually associating the one or more electrical parameters with the smart electrical socket on the display comprises superimposing the one or more electrical parameters on the image of the smart electrical socket.

An illustrative method may facilitate pairing a smart electrical socket with a gateway device, wherein the smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance if any through the plug receptacle, the smart electrical socket further including a wireless interface. The method may include selecting a gateway device, capturing an image of a visual code on the smart electrical socket using a camera of a mobile device, extracting a smart electrical socket identifier from the image of the visual code for the smart electrical socket, providing the smart electrical socket identifier to the selected gateway device, and instructing the selected gateway device to establish a pairing with the smart electrical socket that has the smart electrical socket identifier. In some cases, the method may include providing a gateway identifier of the selected gateway to the smart electrical socket, and instructing the smart electrical socket to establish a pairing with the gateway device that has the gateway identifier. The method may include generating and displaying a commissioning report that includes the established pairings between the gateway device and one or more smart electrical sockets.

An illustrative method may facilitate controlling a smart electrical socket from a mobile device, wherein the smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance if any through the plug receptacle, the smart electrical socket further including a wireless interface. The method may include capturing an image of the smart electrical socket using a camera of a mobile device, displaying at least part of the image on a display of the mobile device, and receiving a gesture from a user via a user interface of the mobile device to control one or more actions of the smart electrical socket. The mobile device may determine and send one or more control commands that are based at least in part on the received gesture. The gesture may include, for example a touch and hold gesture, a swipe gesture, a swipe two finger gesture, twisting the mobile device in a first rotational direction, twisting the mobile device in a second rotational direction, moving the mobile device toward the user, moving the mobile device away from the user, and/or any other suitable gesture that is detectable by the mobile device.

The method may include controlling one or more actions of the smart electrical socket based on the one or more control commands sent by the mobile device. In some cases, the one or more actions may include switching power on to the plug receptacle of the smart electrical socket, switching power off to the plug receptacle of the smart electrical socket, or reducing a power level to the plug receptacle of the smart electrical socket. In some cases, the method may include the mobile device sending the one or more control commands directly to the smart electrical socket. The method may include the mobile device sending the one or more control commands indirectly to the smart electrical socket such as through an intervening gateway/hub device and/or through a remote cloud server.

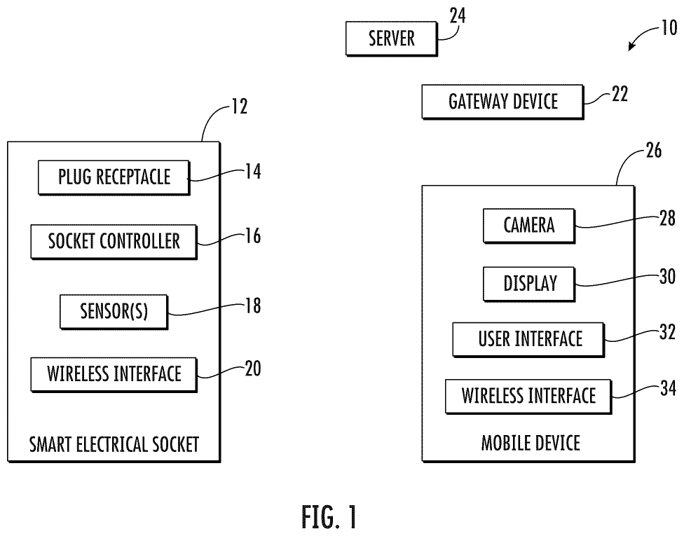

FIG. 1 is a schematic block diagram showing an illustrative connected power system 10. The illustrative connected power system 10 may be deployed within any of a variety of different types and sizes of facilities. The illustrative connected power system 10 includes a smart electrical socket 12. While a single smart electrical socket 12 is shown, it will be appreciated that the connected power system 10 may include any number of smart electrical sockets 12 and in some cases, may include tens, hundreds, or even thousands of smart electrical sockets 12. The smart electrical socket 12 includes a plug receptacle 14. While the smart electrical socket 12 is shown as including a single plug receptacle 14, in some cases, the smart electrical socket 12 may include two or even more plug receptacles 14. The smart electrical socket 12 includes a socket controller 16 that is configured to control whether the smart electrical socket 12 switches power on to the plug receptacle 14 or switches power off to the plug receptacle 14. The smart electrical socket 12 includes one or more sensors 18. The sensors 18 are configured to sense one or more electrical parameters that are associated with the power being provided by the smart electrical socket 12. As an example, the sensors 18 may be configured to measure temperatures within the smart electrical socket 12. As another example, the sensors 18 may be configured to measure a current or another indication of how much power is being provided to an electrical appliance via the plug receptacle 14 of the smart electrical socket 12. In another example, the sensors 18 may be configured to a detect smoke, a carbon monoxide, a CO2, light (visible, UV, etc.) and/or any other suitable sensor. These are just examples.

The smart electrical socket 12 includes a wireless interface 20 that allows the smart electrical socket 12 to communicate wirelessly with other devices. In some cases, the wireless interface 20 may be configured to communicate over a WiFi network. In some cases, the wireless interface 20 may be configured to communicate via Bluetooth, such as over a BLE (Bluetooth Low Energy) network. In some cases, the wireless interface 20 may accommodate a cellular network. The wireless interface 20 may allow the smart electrical socket 12 to communicate with other smart electrical sockets 12 via a mesh network. In some cases, the smart electrical socket 12 may be in wireless communication with a gateway device 22. As an example, the gateway device 22 may function as a hub, and may itself communicate with remote devices such as a cloud-based server 24. In some cases, the smart electrical socket 12 may be commissioned to communicate with the gateway device 22.

A mobile device 26 may be used in combination with the connected power system 10, or the mobile device 26 may be considered as being part of the connected power system 10. The mobile device 26 may be a smartphone, for example. In some cases, the mobile device 26 may be a tablet or a phablet, or a laptop computer. In some cases, the mobile device 26 may be smart glasses such as the Google Glass® smart glasses previously available from Google X. In some cases, the mobile device 26 may be or include a wearable virtual reality goggles. The mobile device 26 includes a camera 28 that may be used to capture images. The mobile device 26 includes a display 30 and a user interface 32. In some cases, the display 30 may be part of the user interface 32. As an example, the mobile device 26 may include a touchscreen display that doubles as the display 30 and as the user interface 32. The mobile device 26 includes a wireless interface 34 that allows the mobile device 26 to communicate wirelessly with other devices. In some cases, the wireless interface 34 is configured to communicate over a WiFi network, a Bluetooth network, or a cellular network.

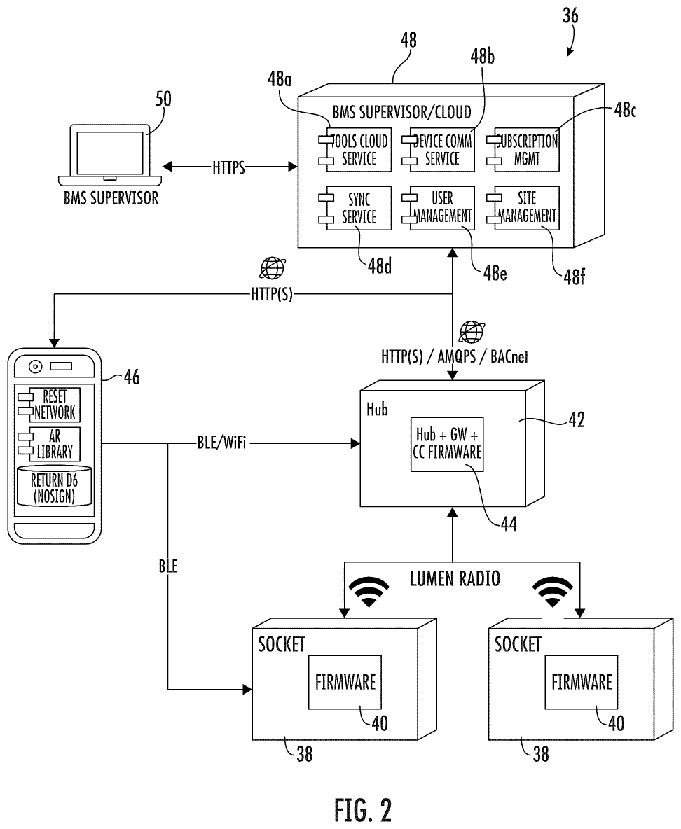

FIG. 2 is a schematic block diagram showing an illustrative architecture 36 that may be utilized with the connected power system 10. The illustrative architecture 36 includes several smart sockets 38 each having firmware 40. The smart sockets 38 may be considered as being examples of the smart electrical socket 12. The smart sockets 38 communicate using a deep mesh or a Lumen radio network with a hub 42, which includes firmware 44. The hub 42 (an example of the gateway device 22 of FIG. 1) communicates via Bluetooth or WiFi with a mobile device 46 (an example of the mobile device 26 of FIG. 1), and the mobile device 46 is able to communicate with the smart sockets 38 via Bluetooth. In some cases, the hub 42 and the mobile device 46 are able to communicate over a wide area network (WAN) such as the Internet with a BM S supervisor 48 that resides in the cloud. As seen, the BM S supervisor 48 includes a number of functions, including tools cloud service 48a, device comm service 48b, subscription management 48c, sync service 48d, user management 48e, and site management 48f. The BMS supervisor 48 communicates over a network with a separate BM S supervisor 50 that may be operated by an operator of the facility.

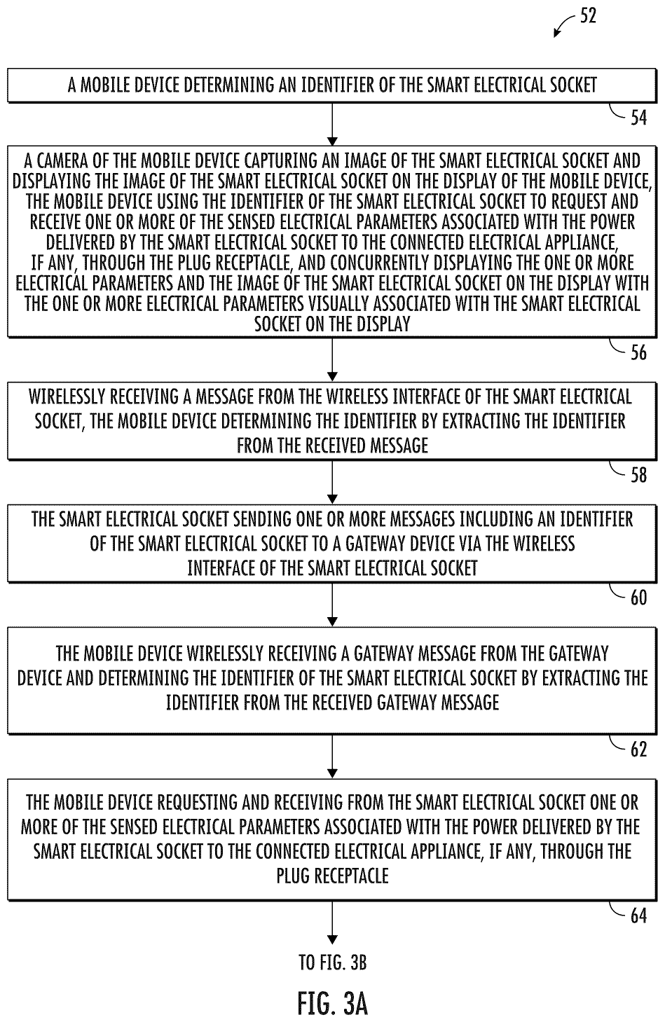

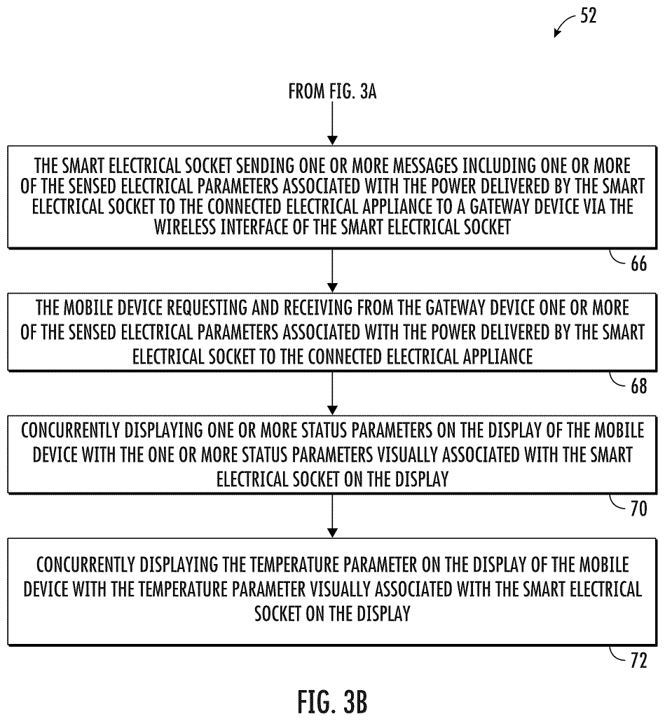

FIGS. 3A and 3B are flow diagrams that together show an illustrative method 52 for visualizing one or more parameters associated with a smart electrical socket (such as the smart electrical socket 12). The method 52 includes a mobile device (such as the mobile device 26) determining an identifier of the smart electrical socket, as indicated at block 54. The camera captures an image of the smart electrical socket and displays the image of the smart electrical socket on the display of the mobile device. The mobile device identifying an identifier of the smart electrical socket in the captured image of the smart electrical socket (e.g. bar code, QR code, etc.). The identifier may correspond to, for example, a unique serial number, MAC address, or other unique identifier. The mobile device uses the identifier of the smart electrical socket to request and receive one or more of the sensed electrical parameters associated with the power delivered by the smart electrical socket to the connected electrical appliance, if any, through the plug receptacle, and concurrently display the one or more electrical parameters and the image of the smart electrical socket on the display with the one or more electrical parameters visually associated with the smart electrical socket on the display, as indicated at block 56.

In some cases, visually associating the one or more electrical parameters with the smart electrical socket on the display of the mobile device may include superimposing the one or more electrical parameters on the image of the smart electrical socket. In some cases, visually associating the one or more electrical parameters with the smart electrical socket on the display of the mobile device may include providing an association line between the one or more electrical parameters that are displayed on the display and the smart electrical socket shown in the image of the smart electrical socket.

In some cases, the mobile device may determine the identifier by extracting the identifier from the image of the smart electrical socket, wherein the identifier is encoded in a visual code (e.g. bar code, QR code) on the smart electrical socket. In some cases, the mobile device may wirelessly receive a message from the wireless interface of the smart electrical socket, wherein the mobile device determines the identifier by extracting the identifier from the received message, as indicated at block 58. In some cases, the smart electrical socket sends one or more messages including an identifier of the smart electrical socket to a gateway device via the wireless interface of the smart electrical socket, as indicated at block 60. The mobile device may then wirelessly receive a gateway message from the gateway device (such as the gateway device 22) and determine the identifier of the smart electrical socket by extracting the identifier from the received gateway message, as indicated at block 62. These are just examples.

In some cases, the one or more of the sensed electrical parameters associated with the power delivered by the smart electrical socket to the connected electrical appliance, if any, through the plug receptacle may include one or more of a voltage value, a current value, a power value and an energy value. In some cases, the method 52 includes the mobile device requesting and receiving from the smart electrical socket one or more of the sensed electrical parameters associated with the power delivered by the smart electrical socket to the connected electrical appliance, if any, through the plug receptacle, as indicated at block 64.

Continuing on FIG. 3B, in some cases the method 52 may include the smart electrical socket sending one or more messages including one or more of the sensed electrical parameters associated with the power delivered by the smart electrical socket to the connected electrical appliance to a gateway device via the wireless interface of the smart electrical socket, as indicated at block 66. The mobile device may then request and receive from the gateway device one or more of the sensed electrical parameters associated with the power delivered by the smart electrical socket to the connected electrical appliance, as indicated at block 68.

In some cases, the one or more parameters associated with the smart electrical socket may include one or more status parameters that indicate whether the smart electrical socket is providing power to the plug receptacle or not providing power to the plug receptacle, and the method 52 may include concurrently displaying one or more of the status parameters on the display of the mobile device with the one or more status parameters visually associated with the smart electrical socket on the display, as indicated at block 70. In some cases, the one or more parameters associated with the smart electrical socket may include a temperature parameter that indicates a current temperature inside of the smart electrical socket, and the method 52 may include concurrently displaying the temperature parameter on the display of the mobile device with the temperature parameter visually associated with the smart electrical socket on the display, as indicated at block 72.

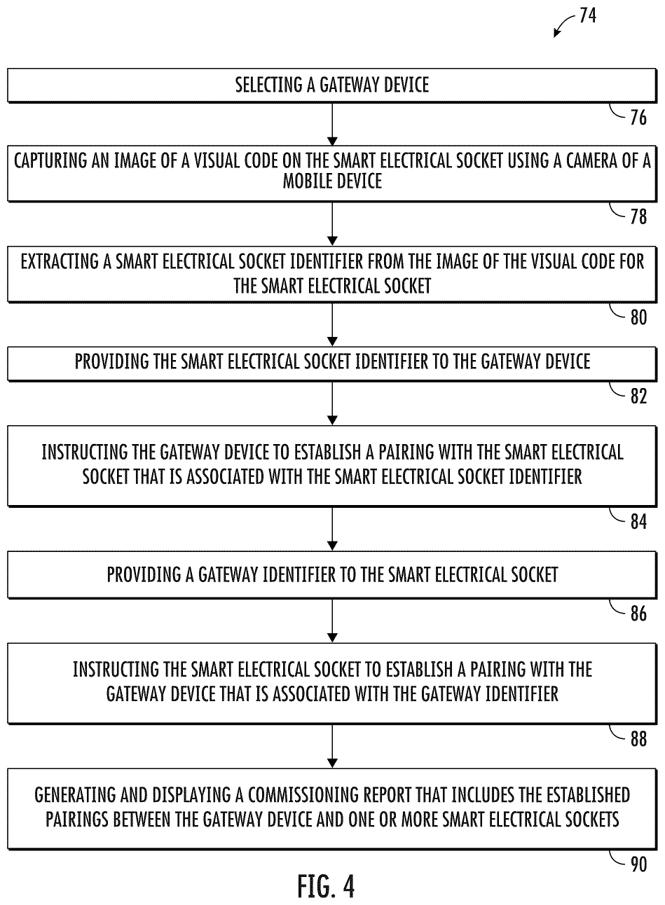

FIG. 4 is a flow diagram showing an illustrative method 74 of pairing a smart electrical socket (such as the smart electrical socket 12) with a gateway device (such as the gateway device 22). The method 74 includes selecting a gateway device, as indicated at block 76. An image of a visual code on the smart electrical socket is captured using a camera of a mobile device, as indicated at block 78. A smart electrical socket identifier is extracted from the image of the visual code for the smart electrical socket, as indicated at block 80. The smart electrical socket identifier is provided to the selected gateway device, as indicated at block 82. The selected gateway device is instructed to establish a pairing with the smart electrical socket that is associated with the smart electrical socket identifier, as indicated at block 84.

In some cases, the method 74 includes providing a gateway identifier of a selected gateway device to the smart electrical socket, as indicated at block 86. The smart electrical socket may be instructed to establish a pairing with the selected gateway device that is associated with the gateway identifier, as indicated at block 88. In some cases, the method 74 includes generating and displaying a commissioning report that includes the established pairings between the gateway device and one or more smart electrical sockets, as indicated at block 90. This may be useful to review and confirm the proper pairing between the smart electrical sockets and the gateway devices of a facility.

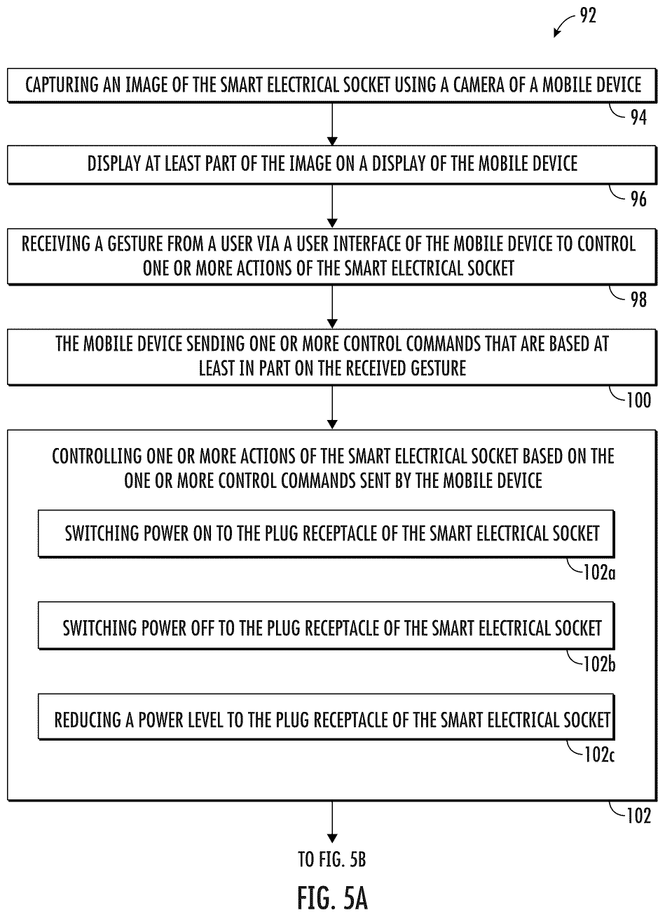

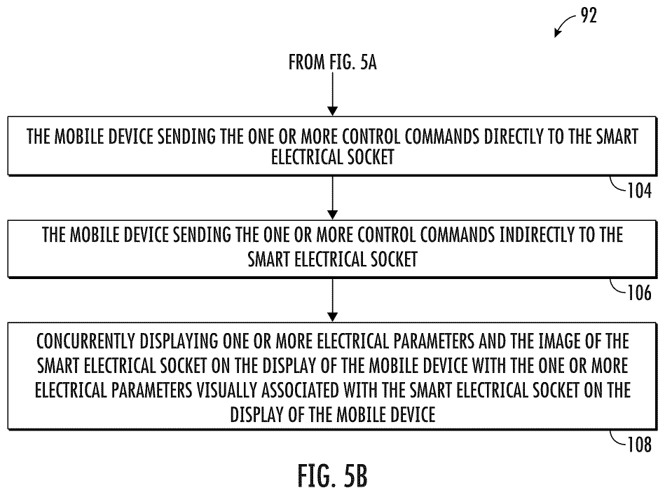

FIGS. 5A and 5B are flow diagrams that together show an illustrative method 92 of controlling a smart electrical socket (such as the smart electrical socket 12) from a mobile device (such as the mobile device 26). The method 92 includes capturing an image of the smart electrical socket using a camera of a mobile device, as indicated at block 94. At least part of the image is displayed on a display of the mobile device, as indicated at block 96. A gesture is received from a user sometimes via a user interface of the mobile device to control one or more actions of the smart electrical socket, as indicated at block 98. The mobile device sends one or more control commands that are based at least in part on the received gesture, as indicated at block 100. One or more actions of the smart electrical socket are controlled based on the one or more control commands sent by the mobile device, as indicated at block 102. The actions may include switching power on to the plug receptacle of the smart electrical socket, as indicated at block 102a. The actions may include switching power off to the plug receptacle of the smart electrical socket, as indicated at block 102b. The actions may include reducing a power level to the plug receptacle of the smart electrical socket, as indicated at block 102. These are just examples.

In some cases, and continuing on FIG. 5B, the method 92 may include the mobile device sending the one or more control commands directly to the smart electrical socket, as indicated at block 104. In some cases, the mobile device may send the one or more control commands indirectly to the smart electrical socket, as indicated at block 106. In some cases, the method 92 may include concurrently displaying one or more electrical parameters and the image of the smart electrical socket on the display of the mobile device with the one or more electrical parameters visually associated with the smart electrical socket on the display of the mobile device, as indicated at block 108. In some cases, visually associating the one or more electrical parameters with the smart electrical socket on the display may include superimposing the one or more electrical parameters on the image of the smart electrical socket.

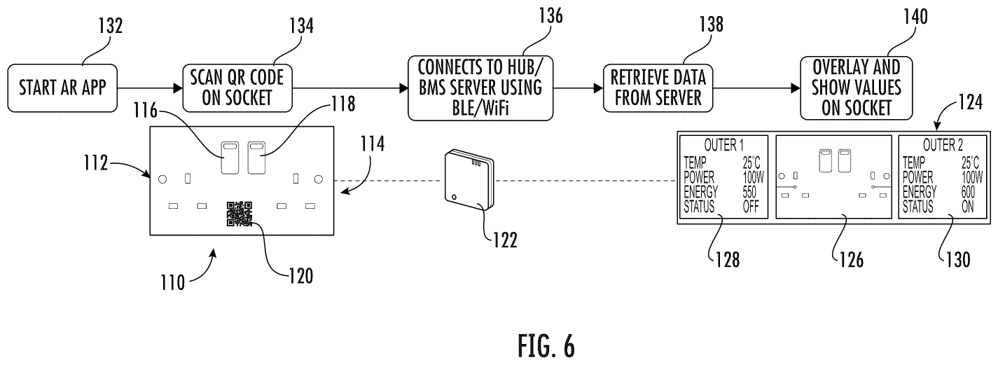

FIG. 6 is a schematic block diagram showing how associated parameters may be overlaid on an image of a smart electrical socket. FIG. 6 shows a smart electrical socket 110 that includes a first plug receptacle 112 and a second plug receptacle 114. The smart electrical socket 110 also includes a first power button 116 that may be used to manually turn on or turn off power to the first plug receptacle 112, and a second power button 118 that may be used to manually turn on or turn off power to the second plug receptacle 114. The smart electrical socket 110 also includes a QR code 120 that may be used by a mobile device to uniquely identify the smart electrical socket 110. A hub 122 is shown as well. On the right side of FIG. 6, an image 124 includes a view 126 of the smart electrical socket 110 on a display of a mobile device. The image 124 also includes a superimposed set 128 of parameters relating to the first plug receptacle 112 and a superimposed set 130 of parameters relative to the second plug receptacle 114.

A process begins with starting an application on a mobile device, as indicated at block 132. The QR code 120 may be scanned via the camera of the mobile device, as indicated at block 134. A connection is formed with the hub 122, as indicated at block 136. Data is retrieved for the smart electrical socket 110 uniquely identified by the QR code 120 from a server, as indicated at block 138. The data may be generated by the smart electrical socket 110, send to the hub 122 and then send to the server. Once the data is retrieved from the server by the mobile device, the values are overlaid and shown on or adjacent the view 126 of the smart electrical socket 110 on the mobile device, as shown as part of the image 124. In some cases, rather than retrieving the data from the server, the mobile device may retrieve the data from the smart electrical socket 110 directly.

In some cases, once an image of the smart electrical socket 110 has been captured by the mobile device, a user may be able to use various gestures to control operation of the smart electrical socket 110. For example, a user may tap their finger on the view 126, forming part of the image 124, in order to instruct the smart electrical socket 110 to turn on or turn off one of the first power button 116 or the second power button 118 in order to either turn on or turn off the power to either the first plug receptacle 112 or the second plug receptacle 114. This may be easier than physically interacting with the first power button 116 or the second power button 118, as the smart electrical socket 110 may be physically located in a region where direct physical access is cumbersome or difficult (e.g. under a desk). Other gestures may be used, such as dragging a finger, or drag-n-drop, may be utilized.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for visualizing one or more parameters associated with a smart electrical socket, wherein the smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance, if any, through the plug receptacle, the smart electrical socket further including a wireless interface, the method comprising:
a mobile device determining an identifier of the smart electrical socket; and
the mobile device having a camera and a display, the camera capturing an image of the smart electrical socket and displaying the image of the smart electrical socket on the display of the mobile device, the mobile device using the identifier of the smart electrical socket to request and receive one or more of the sensed electrical parameters associated with the power delivered by the smart electrical socket to the connected electrical appliance, if any, through the plug receptacle, and concurrently displaying the one or more electrical parameters and the image of the smart electrical socket on the display with the one or more electrical parameters visually associated with the smart electrical socket on the display.

2. The method of claim 1, wherein the mobile device:
determining the identifier by extracting the identifier from the image of the smart electrical socket, wherein the identifier is encoded in a visual code on the smart electrical socket.

3. The method of claim 1, wherein the mobile device:
wirelessly receiving a message from the wireless interface of the smart electrical socket, wherein the mobile device determining the identifier by extracting the identifier from the received message.

4. The method of claim 1, comprising:
the smart electrical socket sending one or more messages including an identifier of the smart electrical socket to a gateway device via the wireless interface of the smart electrical socket; and
the mobile device wirelessly receiving a gateway message from the gateway device and determining the identifier of the smart electrical socket by extracting the identifier from the received gateway message.

5. The method of claim 1, wherein the one or more of the sensed electrical parameters associated with the power delivered by the smart electrical socket to the connected electrical appliance, if any, through the plug receptacle include one or more of a voltage value, a current value, a power value and an energy value.

6. The method of claim 1, comprising:
the mobile device requesting and receiving from the smart electrical socket one or more of the sensed electrical parameters associated with the power delivered by the smart electrical socket to the connected electrical appliance, if any, through the plug receptacle.

7. The method of claim 1, comprising:
the smart electrical socket sending one or more messages including one or more of the sensed electrical parameters associated with the power delivered by the smart electrical socket to the connected electrical appliance to a gateway device via the wireless interface of the smart electrical socket; and
the mobile device requesting and receiving from the gateway device one or more of the sensed electrical parameters associated with the power delivered by the smart electrical socket to the connected electrical appliance.

8. The method of claim 1, wherein visually associating the one or more electrical parameters with the smart electrical socket on the display comprises superimposing the one or more electrical parameters on the image of the smart electrical socket.

9. The method of claim 1, wherein visually associating the one or more electrical parameters with the smart electrical socket on the display comprises providing an association line between the one or more electrical parameters that are displayed on the display and the smart electrical socket shown in the image of the smart electrical socket.

10. The method of claim 1, wherein the one or more parameters associated with the smart electrical socket include one or more status parameters that indicate whether the smart electrical socket is providing power to the plug receptacle or not providing power to the plug receptacle, the method comprising:
concurrently displaying one or more of the status parameters on the display of the mobile device with the one or more status parameters visually associated with the smart electrical socket on the display.

11. The method of claim 1, wherein the one or more parameters associated with the smart electrical socket include a temperature parameter that indicates a current temperature inside of the smart electrical socket, the method comprising:
concurrently displaying the temperature parameter on the display of the mobile device with the temperature parameter visually associated with the smart electrical socket on the display.

12. A method of pairing a smart electrical socket with a gateway device, wherein the smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance if any through the plug receptacle, the smart electrical socket further including a wireless interface, the method comprising:
selecting a gateway device;
capturing an image of a visual code on the smart electrical socket using a camera of a mobile device;
extracting a smart electrical socket identifier from the image of the visual code for the smart electrical socket;
providing the smart electrical socket identifier to the gateway device; and
instructing the gateway device to establish a pairing with the smart electrical socket that is associated with the smart electrical socket identifier.

13. The method of claim 12, comprising:
providing a gateway identifier to the smart electrical socket; and
instructing the smart electrical socket to establish a pairing with the gateway device that is associated with the gateway identifier.

14. The method of claim 12, comprising:
generating and displaying a commissioning report that includes the established pairings between the gateway device and one or more smart electrical sockets.

15. A method of controlling a smart electrical socket from a mobile device, wherein the smart electrical socket includes a plug receptacle for selectively receiving a plug from an electrical appliance, a socket controller for controlling whether the smart electrical socket switches power on to the plug receptacle or switches power off to the plug receptacle, and one or more sensors for sensing one or more electrical parameters associated with power delivered to a connected electrical appliance if any through the plug receptacle, the smart electrical socket further including a wireless interface, the method comprising:
capturing an image of the smart electrical socket using a camera of a mobile device;
display at least part of the image on a display of the mobile device;
receiving a gesture from a user via a user interface of the mobile device to control one or more actions of the smart electrical socket;
the mobile device sending one or more control commands that are based at least in part on the received gesture; and
controlling one or more actions of the smart electrical socket based on the one or more control commands sent by the mobile device.

16. The method of claim 15, wherein the one or more actions include:
switching power on to the plug receptacle of the smart electrical socket;
switching power off to the plug receptacle of the smart electrical socket; or reducing a power level to the plug receptacle of the smart electrical socket.

17. The method of claim 15, comprising:
the mobile device sending the one or more control commands directly to the smart electrical socket.

18. The method of claim 15, comprising:
the mobile device sending the one or more control commands indirectly to the smart electrical socket.

19. The method of claim 15, comprising:
concurrently displaying one or more electrical parameters and the image of the smart electrical socket on the display of the mobile device with the one or more electrical parameters visually associated with the smart electrical socket on the display of the mobile device.

20. The method of claim 19, wherein visually associating the one or more electrical parameters with the smart electrical socket on the display comprises superimposing the one or more electrical parameters on the image of the smart electrical socket.
